(19) United States
(12) Patent Application Publication
(10) Pub. No.: US 2008/0078579 A1
(43) Pub. Date: Apr. 3, 2008

(54) STERILIZATION AND WASHING PROTECTOR FOR CABLE CONNECTORS

(76) Inventor: John Pascaloff, Keswick, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/862,538

(22) Filed: Sep. 27, 2007

Related U.S. Application Data
(60) Provisional application No. 60/847,642, filed on Sep. 28, 2006.

(51) Int. Cl. H02G 15/02

(52) U.S. Cl. 174/74 A

(57) ABSTRACT

A double- (or dual-) ended cap is attached at one end of a cable that allows connectors at both ends of the cable to connect to respective ends of the cap during washing and/or sterilization. A flexible attachment means connects the cap to one end of said electrical cable. When the cable connectors are inserted into corresponding ones of the two holes, the cap provides a seal to protect electrical components of the cable connectors in a sterilizing and washing environment.

### BACKGROUND OF THE INVENTION

1. Field of the Invention

The present invention generally relates to a means for protecting cable connectors from sterilization and washing environments and, more particularly, to a double- (or dual-) ended cap attached at one end of a cable that allows connectors at both ends of the cable to connect to respective ends of the cap during washing and/or sterilization.

2. Background Description

Prior to any surgery, washing and sterilization of all instruments and devices is both required and necessary to prevent infections and cross-contamination. Many surgical instruments are electrically powered, necessitating an electrical cable to be connected between a power source and the surgical instrument. Previously, to wash and sterilize cables that connect surgical instruments to a power source, caps are attached to the connectors at each end of the cable in order to protect the electrical components of the cable connectors.

As shown in FIG. 1, a cable 10 for connecting a surgical instrument to a power source is comprised of a cable 14 having connectors 18a and 18b at either end thereof. The connectors are typically different in design and configuration. For example, the connector 18a is designed for mating connection to a corresponding connector on a power source, while connector 18b is designed for connection to a corresponding connector on the surgical instrument. Each of the the cable connectors have a cap 12a, 12b attached to each end of the cable 14. The caps 12a and 12b are provided with mating apertures or holes for receiving the ends of the connectors 18a and 18b, respectively, and to provide a seal that protects the electrical components of the connectors from the sterilization and washing environment. The caps 12a, 12b are attached to each end portion of the cable 14 by a flexible attachment means, such as a wire 16. The wire 16 ensures that the caps 12a, 12b are not lost during use and are readily available to place over the connectors 18a, 18b of the cable 10 prior washing and sterilizing.

The problem with the prior art is that because the caps 12a, 12b are always attached to the cable 14 by a wire 16 (or other flexible attachment device), the cap 12b on the end that attaches to the surgical instrument will be in the way of the surgeon when using the attached surgical instrument.

### SUMMARY OF THE INVENTION

It is therefore an object of the present invention to provide a solution to the aforementioned problem by eliminating the need for a cap to be attached to the end of the cable that attaches to a surgical instrument.

According to the invention, there is provided a dual-ended cap that is detachably attached to the end of a cable connector that is connected to a power source. This dual-ended cap has respective apertures designed to receive the connectors at either end of the cable. Since this dual-ended cap is attached to the power source of the cable, there is no cap at the surgical instrument of the cable. Therefore, the problem of a cap attached to the surgical instrument end of the cable interfering with the surgeon has been eliminated.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a pictorial representation of a conventional power cable with connectors and caps for use with a surgical instrument; and

FIG. 2 is side view of the dual-ended cap for protecting cable connectors according to the present invention.

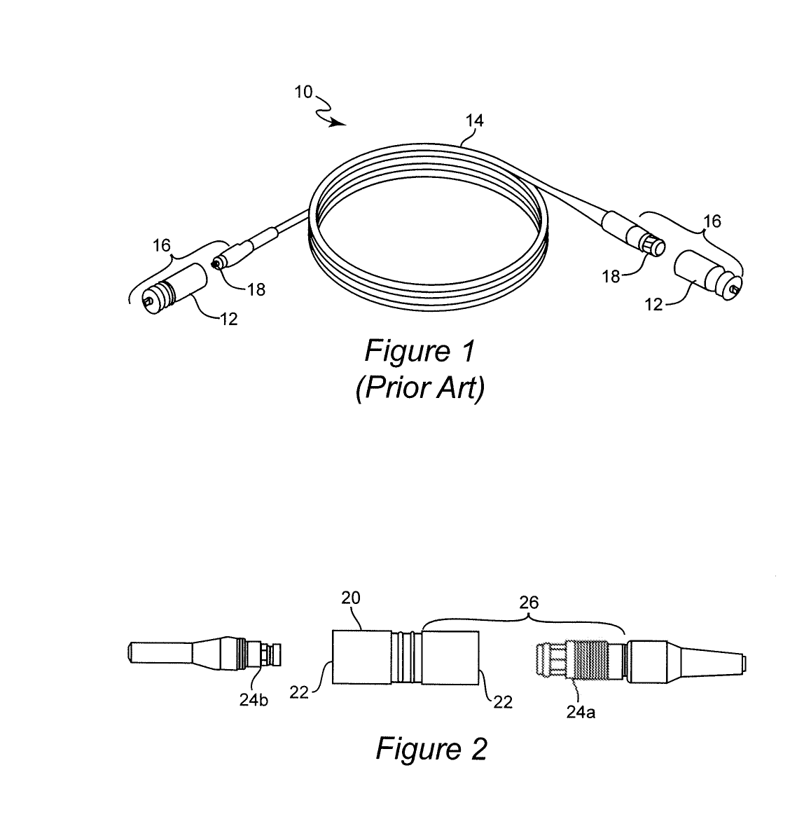

### DETAILED DESCRIPTION OF A PREFERRED EMBODIMENT OF THE INVENTION

Referring again to the drawings, and more particularly to FIG. 2, there is shown a cap 20 of the present invention. This cap has two apertures or holes 22a, 22b at either end for insertion of respective ones of connectors 24a and 24b of the cable. These holes are designed to receive a respective one of the connectors 24a and 24b and seal the ends of the connectors to protect the electrical components of the connectors from the sterilization and washing environment to which the cable is subjected. Further, a wire 26 (or other flexible attachment means connects the cap 20 to only one end of the cable, here illustrated as the end having connector 24a. The wire 26 may be connected to cable, a portion of the connector 24a itself, or a boot which transitions from the cable to the connector. More importantly, the wire 26 is connected to the end of the cable having connector 24a that is connected to the power source, the other connector 24b being reserved for connection to the surgical instrument. Thus, when the connector 24a, in this example, is connected to the power source, the cap 20 is also at the power source end of the cable and out of the sterile field during surgery. Accordingly, the cap 20 does not interfere with the surgeon during use of the surgical instrument, which is connected to the opposite end of the cable, at connector 24b in the illustrated example. When the cable is to be washed and sterilized, the connectors 24a and 24b are inserted into respective ones of the holes 22a, 22b to protect the electrical components of the cable.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A sterilizing/washing protector for cable connectors attached to first and second ends of an electrical cable, comprising:
a cap, said cap having two holes for receiving respective ones of the cable connectors;
a flexible attachment means, said flexible attachment means connecting said cap to one end of said electrical cable,
wherein when said cable connectors are inserted into corresponding ones of the two holes, the cap provides a seal to protect electrical components of said cable connectors in a sterilizing and washing environment.

2. The sterilizing/washing protector for cable connectors recited in claim 1, wherein the electrical cable is used to connect a surgical instrument to a power source.

3. The sterilizing/washing protector for cable connectors recited in claim 2, wherein a first one of the cable connectors is designed to connect to the power source, and a second one of the cable connectors is designed to connect to the surgical instrument, each of the two holes of the cap being formed to receive a respective one of the first and second cable connectors.

4. The sterilizing/washing protector for cable connectors recited in claim 3, wherein the flexible attachment means connects the cap to a location at an end of the cable adjacent to the first one of the cable connectors.
